(19) United States
(12) Patent Application Publication
(10) Pub. No.: US 2022/0405683 A1
(43) Pub. Date: Dec. 22, 2022

(54) Autonomous System for Optimizing the Performance of Remote Workers

(71) Applicants: Benjamin I. Traub, Englewood, FL (US); Benjamin E. Traub, Englewood, FL (US)

(72) Inventors: Benjamin I. Traub, Englewood, FL (US); Benjamin E. Traub, Englewood, FL (US)

(21) Appl. No.: 17/805,509

(22) Filed: Jun. 6, 2022

Related U.S. Application Data
(60) Provisional application No. 63/202,567, filed on Jun. 16, 2021.

(51) Int. Cl. G06Q 10/06

(52) U.S. Cl. CPC G06Q 10/06398

(57) ABSTRACT

Detecting distractions and creating stimulus to increase a motivation, e.g., of a home office worker using an AI system. A creation module creates new stimulus for motivation of users. A stimulus module tests the new stimulus that are created by the creation module, and recommends stimulus that are created with the stimulus module that are likely to modify a user's future behavior. A data Module records the user's reaction to the stimulus created by the stimulus module, the Data Module monitoring and recording metrics, using a user's Software, Behavior, Environment and Biometrics indicating whether or not that stimulus was effective. A prediction module analyzes the data to predict user's future behavior to the stimulus that will result in avoidance of negative behavior or pursuit of positive behavior.

This application claims priority from Provisional Application No. 63/202,567, filed Jun. 16, 2021, the entire contents of which are herewith incorporated by reference.

### BACKGROUND

Data from a variety of sources can be used to make predictions of future behavior.

In recent years, computing devices have substantially proliferated in homes, workplaces, and other places. These devices have made it possible to capture, track, and record activity of users, both in the physical world and in the digital world. In addition, advances in computer software have made it possible to digitally monitor user behavior (e.g., tracking mouse clicks, keypresses, etc.). Combined, these sources of information have made it possible to analyze user behavior.

Previous attempts to analyze user behavior have existed.

In recent years, computing devices have substantially proliferated in homes, workplaces, and other places. These devices have made it possible to capture, track, and record activity of users, both in the physical world and in the digital world. In addition, advances in computer software have made it possible to digitally monitor user behavior (e.g., tracking mouse clicks, keypresses, etc.). Combined, these sources of information have made it possible to analyze user behavior.

Previous attempts to analyze user behavior have specifically modeled a user's reaction to a particular intervention to produce a particular behavior.

### SUMMARY

The present application describes an autonomous, machine-learning (A.I.) system for a remote worker system, that predicts human behavior, then intervenes with digital motivation stimulus designed to motivate users toward pursuit of positive behavior or avoidance of negative behavior.

Embodiments use A.I. methods such as Natural Language Processing, to create new stimuli (such as encouraging text messages), then testing that stimuli. In this way the prediction of user's performance and application of stimulus forms a self-contained, self-optimizing invention for autonomously enhancing productivity of remote workers.

Embodiments describe precursor data points that can be collected, then correlated with subsequent behavior. Predictions may be made using statistical methods such as Regression and Classification techniques, as described herein.

### BRIEF DESCRIPTION OF THE DRAWINGS

FIG. 1 shows a computer system, and the different modules used according to the present system; and

FIG. 2 illustrates a data flow between those modules.

### DETAILED DESCRIPTION

An autonomous, machine-learning (A.I.) system is described that predicts future behavior of remote workers, by monitoring the actions of those remote workers. The system determines and provides a stimulus designed to motivate users toward pursuit of positive behavior or avoidance of negative behavior of those remote workers. before that behavior has occurred

Applications for this system are numerous, including work productivity, as described as an embodiment herein. This system can also be used to learn stimuli for prisoner reform, addiction treatment or athletic training. An embodiment as described herein operates to optimize the productivity of remote workers.

AI predictions and stimuli can take different forms. An example of a software precursor is as follows. User A, who is driving in their networked car, is 10 minutes from their home office. The Prediction system detects the user will not be back in time for a video meeting which begins in 2 minutes. The system sends an audio message through the car speakers . . . “would you like to send an SMS message to your client to let them know that you will be late?” The user may answer with a voice command or dashboard-keypad response, all of which is logged by the Data Module. In this example, the stimulus was triggered by the A.I.-driven prediction of a missed appointment, with the stimulus to take action (send SMS to client) to avoid consequences of being late.

User behavior prediction can take any form.

An example of user behavior prediction uses real-time monitoring of the user's typing speed as the predictor, to predict further decline in productivity. A stimulus message from the system can encourage the user to do something to refresh and hence become less likely to decline—e.g., take a 5-minute break or to drink a glass of water or do 20 jumping jacks.

Environmental prediction can use a weather forecast as a predictor. A prediction for a sunny day, or good surf, as predicting a higher probability of the user not clocking in for work. The response can be a message from the system informing the user that there is an important deadline that cannot be missed.

Biometrics prediction can use a wearable device to determine information about the user's current state. One embodiment can indicate that the user is still sleeping ten minutes before their shift is scheduled to begin. This predictor would then predict the user will be late. The stimulus response can be a vibration being sent to the user, e.g., their IOT wristband, to wake them up.

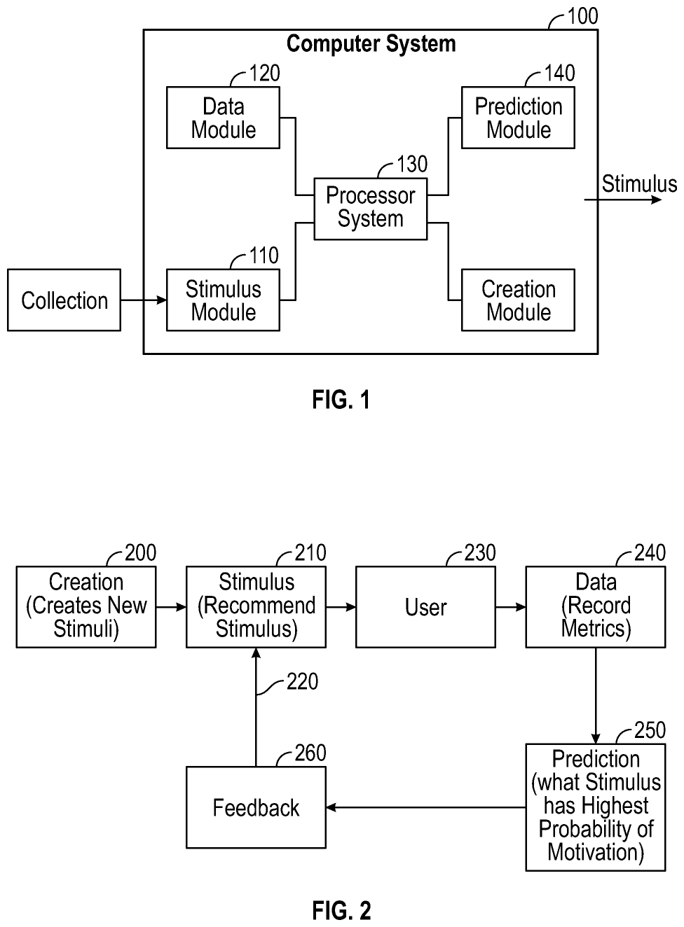

An embodiment is illustrated in FIG. 1. A computer system 100 can include one or many different computers, connected together. For example, the computer system can be formed of a handheld computer such as a cellular phone or tablet, connected or connectable to a vehicle mounted computer, which is connected or connectable to a backend computer.

The computer system 100 includes a stimulus module 110, a data module 120, a system module 130, a prediction module 140, and a creation module 150. These operate in conjunction with one another as described herein. Information is collected by a number of different collection hardware and software, and the stimuli are delivered in the system as also described herein.

The data module 120 may include a combination of hardware and/or software that is configured to receive and record data from one or more data sources. In some embodiments, the data module 120 may receive static data representing characteristics of one or more users (including name, age, education, job role, test scores, etc.). In addition, the data module 120 may receive environment data collected from one or more devices, such as microphones, cameras, thermometers, oxygen sensors, air quality sensors, global position system (GPS) devices, and/or other devices, either as single data points, or as time series data, or in any other form.

The prediction module 140 may include a combination of hardware and/or software that includes one or more machine learning models (or a combination of models, such as a cascade of models) that are each trained with some combination of data collected by the data module 120 as described above. At least one of the machine learning models of the prediction module 140 may be trained to determine an association between, for example, one or more signals from environment data and a subsequent change in a particular user's behavior. For example, if the temperature in a user's office increases above a threshold level, and the user's average number of words typed per minute decreases, a machine learning model of the prediction module may learn this causal relationship (e.g., using supervised learning on labeled datasets, unsupervised learning on unstructured data, etc.) . . . .

In operation, the creation module 150 reviews and creates new stimuli. For example, the creation module 150 may receive lists, or receive the stimuli in any other way.

As those new stimuli are developed by the Creation module 150, they are tested by the Stimulus module 110. The user's subsequent behavior after the stimuli is recorded by the Data module 120. The results of the user's actions are analyzed by the Prediction module 140. This can create predictions of future behavior. The stimulus-efficacy becomes more accurate as more data accumulates, and stimuli becomes more effective at motivating users towards positive behavior or away from negative behavior.

The modules interact within the performance-optimization workflow as described herein and shown in FIG. 2.

The flow starts with the creation module at 200 creating new types or variations of stimuli. This can be imported from a list from a database of different stimuli or created as described further herein.

The stimulus module, at 210, tests the new stimuli that are created by the system. The Stimulus Module 110 at 210 in the flow applies or recommends stimulus that are created with the stimulus module, with the goal of modifying the user's future behavior. The stimulus recommended from the stimulus module at 210 is sent to the user at 230.

The Data Module records at 240 the user's reaction to the stimulus created by the stimulus module, and whether or not that stimulus was effective. The Data Module 120 monitors and records metrics, using a user's Software, Behavior, Environment and/or Biometrics.

Based on this data recorded, at 250, the prediction Module 140 predicts user's future behavior. The prediction Module also predicts stimulus that will result in avoidance of negative behavior or pursuit of positive behavior.

Based on this recorded data, the prediction Module 140 self-learns at 250 what type of stimulus is required to obtain the desired future behavior, further improving the system's ability to make accurate predictions. This information is fed back by the feedback module at 260. Thereafter, feedback 220 from the prediction module 250 provides information to the stimulus module about which stimulus has been successful in changing the user behavior.

Additional details about the different modules are provided herein.

The Data module collects data from a variety of sources, and records structured data in a database, and tags or otherwise classifies unstructured data, typically associating this data with a specific user or cohort such as demographics or job-role.

Data may be categorized into active data and static data.

Active data includes metrics from a variety of real-time sources, such as the environment, user-biometrics or user-behavior.

Static data is information that rarely changes, such as name, age, education, job-role, benchmark performance data and the like. Static data also includes the accumulated, historical data from Active sources. Among other things, static data allows the system to organize users into logical cohorts such as by job-role or demographic cluster.

By testing various stimuli across many users, probabilities can be established for user-response to specific stimuli in various situations. These probabilities can be calculated for specific users or for entire groups (cohorts). Static profile data, including demographics or job-role could thereby be used in the prediction of future behavior, even for new users. Static profile data can include information about the user's working location, as described herein, such as air quality, temperature, and other such information.

Categories of data may include . . .

Profile (static data)

Name

Age

Education

Job-role

Benchmark performance data (interview test data, etc.)

Environment (active data)

Environmental data may be collected via electronic listening devices, computer, mobile phone, webcam, thermometer, oxygen sensor, gps, to record metrics such as:

Audio

Video

Temperature

Air quality

Location

Computer statistics (e.g. CPU temperature)

Biometrics (active data)

Data may be collected via Biometric Monitoring Device (BMD) and includes metrics including:

Heartbeat

Blood pressure

Blood oxygen saturation

Sweat

Respiratory patterns

Cortisol levels

User Behavior (active data)

Productivity data may be collected via wearables, mobile phone, webcams or desktop and mobile applications such as time trackers. Metrics may include:

Spell & Grammar checker. Too many errors can indicate fatigue.

File opening frequency

File saving frequency

Eye tracking (e.g. look-away stats as an indicator of focus)

Focus elements (e.g. are work-related programs or websites open?)

Distraction elements. Are there too many programs or tabs opened? Are there non-work programs or websites opened?

Quantity of keystrokes

Quantity of mouse movements

Screen-change frequency

Clock-in time

Break frequency

Session duration

Motion i.e. stationary vs walking

Software Activity (active data)

Appointment calendar

Email inbox

Messaging (SMS, Skype, dialers, etc.)

The Prediction module performs analysis on data stored in the Data Module at 250 and includes self-learning algorithms that calculate probabilities of future behavior.

The Prediction module also predicts what type of stimulus has the highest probability of motivation: specifically which stimulus is most efficient at motivating a user towards the pursuit of positive future behavior or the avoidance of future negative behavior.

In one embodiment, the prediction module uses rules to identify negative or positive behavior. An example of a rule that can be used is that faster typing=positive behavior, slower typing=negative behavior.

Before a prediction of future behavior can be made, correlations are established between certain precursor data and subsequent behavior. The Prediction module operates to identify these correlations using methods such as Regression (e.g. Linear Regression) or Classification techniques (e.g. Logistic Regression) to identify causal or non-causal relationships between precursor data and subsequent future behavior data.

In one embodiment, Classification analysis of incoming audio data reveals that children entering a home-office correlates with a subsequent drop in worker productivity, measured as degraded typing speed or an increase in spelling errors.

Prediction of behavior can be performed using supervised learning methods on training data (children entering the office=drop in productivity), however; the system also operates to self-learn which precursor data correlates with reduced productivity using methods such as Deep Reinforcement Learning, which enable the system to self-learn how to make better predictions of future behavior.

Predictive cohort models for well defined user-clusters such as job-roles or demographics may be identified as data accumulates, then used to predict behavior even for new users who belong to those cohorts. Sample size plays an important role, as larger sample sizes tend to result in more accurate predictions. With enough data from individual users, predicting their behavior may be made based partially or entirely on that individual user's data rather than cohort models. The individual's personal data may prove to be more accurate in predicting that user's future behavior than a cohort model.

Predictions can be short term. One example of such a prediction is that distraction leads to imminent lower productivity. Predictions can also be longer term or more generalized. An example of a long-term prediction is a pattern of being late to meetings may correlate with other future commitment failures such as failure to work a certain number of hours in a given week, or even ability to maintain long-term commitment to the job.

The system may use its learning tactics to predict these failures and prompt supervisors to take action, which may include altering recruitment plans. While not directly changing that user's behavior, this example shows how the system may be used by an organization to solve related corporate goals.

Once correlations are established, the system can predict future behavior based on the available data and communicate this prediction to the Stimulus Module.

The Stimulus module may automate the delivery of stimuli, such as the delivery of a motivating message to the user. As one example of a scenario that could be used, if a user's webcam or listening device provides data that children have entered the home-office, the Stimulus Module may display a visual prompt on the user's computer screen or phone; “Tell the kids that you love them, then close your door!”

The Stimulus module interacts with devices capable of messaging, such as a user's mobile device or computer, but may include any networkable messaging system including a user's car stereo or a wearable device.

If the Prediction Module predicts that an existing stimulus from the library will not be effective at altering future behavior, the Stimulus Module may test new stimuli produced by the Creation Module. In another embodiment, the system can execute instructions to take more drastic measures. An example of such a drastic measure is system lock the user out of the time tracking application and disallow the worker from tracking time until they have confirmed their environment is once again suitable for focused work.

The Stimulus module may make recommendations for third-party intervention, such as sending an alert to a supervisor with a prompt to confront the user.

Delivery methods of stimuli may include;

Text prompts (push notification, email, sms, on-screen display)

Audio prompts (computer audio, mobile apps, robo call, car speaker)

Visual stimulation such as onscreen images or animations

Physical stimulation (e.g. vibration on wearable or phone)

Emergent technologies such as automated supplement injection or communication with the user's nervous system or wearables such as smart glasses.

Types of stimuli may include;

Motivational encouragement “You are doing well! Keep it up.”

Reminders of reward for good performance

Warnings of loss of reward for bad performance

Game play, where good metrics are converted into points which can be used to keep score and compared with other users.

Feedback requests (can you work 30 more minutes? YES/NO)

Intervention by a peer or authority figure

Virtual intervention by a computer modeled avatar of a peer, authority figure or coach. “Hi, I am John, your virtual coach. Can you work another 30 minutes?”

The creation module can develop entirely new stimuli, such as;

Encouraging statements; “work 30 minutes more to be put on the leader list!”

Commands; “Your supervisor has been notified: work 30 more minutes before you quit for the day!”

Requests for feedback; “Can you work another 30 minutes before you quit for the day? Select YES or NO”

Combinations; “Your supervisor has been notified: can you work 30 more minutes today? Select YES or NO”. You'll be put on the leader list!

The method used to create new stimuli will depend on the type of stimuli being created. For example, motivational statements could leverage a natural language generation model such as GPT-2 or GPT-3 to construct human-like motivational messages. Creation of stimulating audio files could be created using a deep neural network such as MuseNet.

The system may be used to monitor the environment and performance of a professional writer who works in a home office. In this example, the user's webcam may be used to monitor the work environment. Using A.I. methods such as computer vision, the system can identify when certain non-work people, such as children, enter the office. The system leverages additional machine learning to analyze historical and real time data to predict a decline in the performance of the writer due to distraction of those non-work people entering the office. The system leverages machine learning to predict the outcome of delivering various types of stimuli to the user, and selects one that the system predicts will have high probability of motivating the writer to keep working. The system delivers the selected stimulus to the writer, encouraging them to clear their office of these people. This stimulus might be in the form of an encouraging message, delivered to the user through any available device such as phone, wearable or computer. The system continues to monitor the writer's performance, and uses subsequent performance data to assess whether the stimulus was effective at helping the writer avoid a decline in productivity.

Another example: Data subsystem captures user's typing speed, air temperature, and noise levels. Prediction subsystem models trained to predict relationship between these variables. Precursors identified: if air temp is below 60 F or above 78 F, WPM drops; if noise level above 70 dB, WPM drops. Stimulus subsystem generates message to adjust air temperature, suggest a change in location to the user, or put in earplugs. GAN used to generate the exact messages with different length/tone/etc., and the best message content is determined after testing each generated notification (i.e., to determine which message would have the greatest likelihood of influencing the user to adjust temperature/reduce perceived noise levels).

A machine learning model that factors in temporality (e.g., a recurrent neural network, LTSM, etc.) may initially be trained on user behavior data that embeds therein relationships between “precursors” and user behaviors. A pretrained model may be used (e.g., a generative adversarial network, or GAN, among other possible model architectures) to generate “stimuli.” These stimuli may be provided to users, and their responses to the stimuli may be recorded, stored, and/or used as additional training data. This additional training data-comprised of user behavior responses to various stimuli—may then be used to further train (e.g., retrain, use transfer learning, etc.) a temporal model that includes causal associations between stimuli and responsive user behavior. A temporal model may be any machine learning model, statistical model, or some combination thereof that processes sequences of data such as time series data and classifies or predicts the occurrence of events or changes in one or more data metrics (e.g., a recurrent neural network (“RNN”), a Long Short-Term Memory (“LSTM”) network, etc.).

Such temporal models may also be trained on user behavior data to identify precursors subsequent to user behaviors. As described herein, a “precursor” generally refers to a pattern of user behavior determinable from one or more sources of information associated with a corresponding behavior (or change in the one or more sources of information indicative of a user's behavior) that occurs after the precursor. An example precursor may be an increase in the amplitude of auditory noise levels captured by a microphone nearby a user performing work, which may be determined to be associated with a subsequent decrease in that user's average number of words typed per minute on their computer. Other example precursors are described herein in further detail.

In some embodiments, one or more temporal models may be trained based on data collected from observations of user behavior in response to one or more stimuli after detecting one or more precursors, and prior to a predicted change in the user's behavior in response to the one or more precursors. For example, an example stimuli in response to detecting an increase in auditory noise levels as described above may include causing a user's computer or smartphone to receive a notification that suggests the user put in ear plugs to avoid losing focus. After this notification is sent, the user's average number of words typed per minute on their computer may be captured by software and stored as further training data, which includes therein temporal patterns between precursors, changes in user behavior in response to those precursors, and relative changes in user behavior when intervening stimuli are provided prior to the predicted change in user behavior in response to the stimuli—in effect, enabling the model to not only associate precursors with resulting user behavior, but also predict how users will respond to the tested stimuli.

The process by which stimuli are generated and “tested”—that is, provided to the user as an intervention after detecting a precursor, and before a predicted change in user behavior—may be manually or automatically performed. For example, a generative model may be used to select and/or generate stimuli (e.g., the contents of a notification, the tones of an audible sound, etc.), which are subsequently tested and used to gather training data to model and predict user behavior in response to precursors and various stimuli. As defined herein, the term “test” (in the context of testing stimuli) may refer to one or more computer-implemented operations that involve generating, predicting, or otherwise creating a stimulus that is perceived by the user (or at least intended to be perceived by the user) and recording a change (or no change) to one or more aspects of the user's behavior in response to perceiving the stimulus. Further, as described herein, the term “user behavior” may generally refer to one or more data sources and/or metrics derived therefrom associated with or indicative of a user's behavior for one or more activities, such as measures of a user's productivity for a given task (e.g., typing speed, number of tasks completed per unit of time, percentage of time that a user's attention is on a particular object or task extracted from pupil tracking or other attention-determining means, etc.).

The above-described invention may be described systematically as a computing system comprising at least four subsystems: a data subsystem, a prediction subsystem, a stimulus subsystem, and a creation subsystem. Each subsystem may include a combination of software and/or hardware (e.g., generic computing hardware, specialized hardware for accelerating the performance of machine learning tasks, and/or some combination thereof) and configured to carry out operations and computational tasks. It will be appreciated by persons of ordinary skill in the art that machine learning tasks such as training and inference may involve executing software on two or more computing devices, or on a virtual machine powered by one or more computing devices (e.g., cloud computing). Accordingly, the present disclosure may refer to “modules,” “subsystems,′” or other units of computational tasks that are associated with a specific subset of functions for carrying out aspects of the present invention.

The data subsystem may include some combination of hardware and/or software for collecting data from one or more sources related to users and/or users' environments. For example, the data subsystem may include software applications that track metrics indicative of a user's work productivity, such as typing rate or number of tasks completed over a period of time. The data subsystem may also capture and/or store biometric and/or demographic data associated with users, such as age, ethnicity, national origin, job title, and/or other non-temporal information associated with the user. In addition, the data subsystem may capture and/or store environmental data associated with users, such as the number of persons in an office, the time of day, auditory noise levels, temperature, humidity, gas levels, air quality, and/or other environmental metrics representative of the environmental conditions within which a user is performing a task. In some embodiments, the data subsystem may use algorithms and/or feature extraction models familiar to persons of ordinary skill in the art to extract features from environmental, biometric, and/or time series data—with those features derived from “raw” data sources also being stored by the data subsystem. In some implementations, the data subsystem may include sensors, transducers, cameras, and/or other input devices that capture input data for storage, feature extraction, and/or further processing.

The prediction subsystem may include some combination of hardware and/or software for predicting the occurrence of events based on data from the data subsystem. For example, the prediction subsystem may include one or more machine learning models and/or statistical models for classifying data or patterns of data from the data subsystem (e.g., convolutional neural networks (“CNNs”)), estimating or predicting future values of one or more metrics (e.g., Random Forest model, Logistic Regression model, etc.), and/or predicting future events or patterns of user behavior (e.g., RNNs or LSTMs). For example, a Random Forest model may be trained to predict a number of hours that a particular individual will work on a given day based on previously collected data, such as the particular user's number of hours worked the previous day, week, average number of hours worked on that day of the week, the predicted environmental conditions on the given day, and/or other factors. As another example, a logistic regression model may be developed that estimates the likelihood that a particular user will come into the office on a given day. As yet another example, a CNN may be trained to detect the presence of a person at a desk or in front of a computer (e.g., classifying the state of an individual as either “present” or “absent” at a desk). As a further example, another CNN may be trained to detect whether a person is paying attention to a computer screen, and extract therefrom that user's attention level (e.g., classifying the individual as either “paying attention” or “distracted,” or some confidence interval between those two classifications). It should be understood that the term “prediction” as described with respect to the prediction subsystem may refer to either classifying data, estimating unknown or future metrics, predicting a change in one or more metrics over time using one or more machine learning models and/or statistical models.

The stimulus subsystem may include some combination of hardware and/or software for generating, producing, or otherwise causing the performance of stimuli to be perceived by users. In some embodiments, the stimulus subsystem may include one or more software applications that generate, transmit, and/or otherwise produce notifications on a user's computing device, smartphone, speakers, and/or other human-computer interface. For example, the stimulus subsystem may include a push notification system that generates and transmits a message to a user, which the user may subsequently perceive on that user's smartphone or computing device. As another example, the stimulus subsystem may be embedded within an application on a user's computer or smartphone, and may modify aspects of a user interface to reduce the likelihood of reduction in user productivity (e.g., the stimulus being a change in the user interface such as dimming regions of the screen, reducing audio output levels, producing tooltip messages that direct the user's attention to a particular element of a user interface, etc.). In some implementations, the stimulus subsystem may receive stimuli that are automatically generated by a creation subsystem, which is described in further detail below.

The creation subsystem may include some combination of hardware and/or software for training models and automatically generating stimuli. In the context of the creation subsystem, the term “generating” may generally refer to an automated process by which a trained model (e.g., a Transformer, GAN, or other generative network) automatically creates one or more stimuli that may be used by the system to test new stimuli and gather additional training data. For example, the creation subsystem may automatically generate a set of encouraging messages to embed in a notification that is transmitted to a user's computing device and/or smartphone. The system may test each of the automatically-generated notification messages, with the data subsystem capturing any responsive changes in user behavior. The prediction subsystem may then be used to train a model to identify patterns and/or causal relationships between one or more of the automatically-generated stimuli and its impact as an intervention between a precursor and a predicting change in a user's behavior. In effect, the creation subsystem may be used to automatically discover new stimuli that may be used to mitigate what would otherwise be an unmitigated decrease in user productivity by intervening with the stimuli after detecting a precursor. In some implementations, the creation subsystem's generative model(s) may also be re-trained using training data captured from stimuli testing, such that the generative model(s) may over time improve in its/their ability to generate effective stimuli.

Some example implementations of the above-described system are described in greater detail below and with respect to the drawings.

Although only a few embodiments have been disclosed in detail above, other embodiments are possible and the inventors intend these to be encompassed within this specification.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An autonomous, machine-learning system, comprising:
a computer system, programmed to include:
a creation module that reviews and creates new stimulus;
a stimulus module which tests the new stimulus, by providing a stimulus to a user;
a data module that records data including the user's subsequent behavior after the stimulus;
a prediction module that creates predictions of future behavior responding to the stimulus, based on the data recorded by the data module,
where the computer system detects a precursor of a behavior, and creates a motivation stimulus, based on data analyzed by the prediction module as one of the stimulus, that motivate users toward pursuit of a positive behavior or avoidance of a negative behavior.

2. The system as in claim 1, where the creation module postulates certain stimulus, and reviews different reactions that happen after the stimulus.

3. The system as in claim 1, where the creation module reviews and creates new stimulus with a goal of modifying the user's future behavior.

4. The system as in claim 1, where the system monitors remote workers, and where the motivation stimulus include stimulus that are predicted by the prediction module to create desired future behavior of making the worker work more efficiently.

5. The system as in claim 4, wherein the stimulus include data about the user's working location.

6. The system as in claim 4, wherein the stimulus includes biometric information.

7. The system as in claim 4, wherein the stimulus include productivity data of the user, collected by monitoring the user.

8. The system as in claim 1, wherein the prediction module predicts a type of stimulus that has a highest probability of motivating the user, by identifying positive and negative behavior.

9. The system as in claim 1, wherein the prediction module creates predictions for cohorts, and predicts similar behavior from other individuals outside the cohorts, based on the results of the cohorts.

10. The system as in claim 1, wherein the stimulus includes messages to the user.

11. The system as in claim 1, wherein the stimulus includes motivational messages to the user.

12. The system as in claim 1, wherein the system monitors environment of a home office, determines a presence of people in the office previously associated with lower work productivity, and delivers a stimulus to the user encouraging the user to clear their office of said people.

13. A method of detecting distractions and creating stimulus to increase a motivation, comprising:
in a computer, using a creation module to create new stimulus for motivation of users;
using a stimulus module in the computer, for testing the new stimulus that are created by the creation module, and recommending stimulus that are created with the stimulus module that are likely to modify a user's future behavior;
sending a stimulus recommended from the stimulus module to the user;
using a data module to record data including the user's reaction to the stimulus created by the stimulus module, the data module monitoring and recording metrics, using a user's software, behavior, environment and biometrics, indicating whether or not that stimulus was effective; and
using a prediction module in the computer for analyzing the data to predict user's future behavior to the stimulus that will result in avoidance of negative behavior or pursuit of positive behavior, and to self-learn, which stimulus is likely to obtain the desired future behavior.

14. The method as in claim 13, further comprising feeding back information about the type of stimulus is likely to obtain the desired future behavior to the stimulus module indicating which stimulus has been successful in changing the user behavior.

15. The method as in claim 13, wherein the stimulus include data about the user's working location.

16. The method as in claim 15, wherein the stimulus includes productivity data of the user collected by monitoring the user.

17. The method as in claim 13, further comprising using the prediction module for predicting ae type of stimulus that has the prop highest probability of motivating the user by identifying positive and negative behavior.

18. The method as in claim 13, comprising creating stimulus which includes motivational messages to the user.

19. The method as in claim 13, comprising monitoring environment of a home office, determines the presence of people in the office previously associated with lower work productivity, and delivering a stimulus to the user encouraging the user to clear their office of said people.

20. A method of generating a stimulus output, comprising:
retrieving one or more machine learning models trained for predicting user behavior, wherein the one or more machine learning models were trained using (i) static data representative of characteristics of users and (ii) telemetry data representative of activity associated with the users, and wherein the one or more machine learning models are configured to receive as an input a combination of static data and telemetry data;
receiving, at a first time, one or more telemetry data points representative of behavior of a particular user;
predicting, based on the one or more telemetry data points and the one or more machine learning models, a potential future behavior of the particular user, wherein the potential future behavior is predicted to occur at a second time that is after the first time;
predicting, based on the potential future behavior of the particular user, that producing a stimulus output to be perceived by the particular user is likely to prevent the user from performing potential future behavior; and
generating, at a third time that is after the first time and before the second time, a stimulus output to be perceived by the user.
